(19) United States
(12) Patent Application Publication
(10) Pub. No.: US 2026/0141591 A1
(43) Pub. Date: May 21, 2026

(54) Global History Mapper: A Collaborative Platform for Digitizing Human History

(71) Applicant: Ran Zou, Kowloon (HK)

(72) Inventor: Ran Zou, Kowloon (HK)

(21) Appl. No.: 18/950,234

(22) Filed: Nov. 18, 2024

(51) Int. Cl. G06T 11/60; G09B 5/02

(52) U.S. Cl. CPC G06T 11/60; G09B 5/02; G06T 2200/24

(57) ABSTRACT

The proposed invention is a dynamic platform designed to revolutionize the visualization and recording of human history. It is an HTML/JAVA-based system accessible through any browser, facilitating simultaneous edits on a map to document historical events and the evolution of civilization across Earth's history. Crowd input forms the backbone of this platform, with the goal of digitizing human history onto a single map for each time period, potentially creating one unique map for each month in human history. This ambitious endeavor aims to comprehensively digitize all global historical events and cultural establishments. Users can seamlessly “flip” between different time periods, allowing for the visualization of the evolution of key cultural establishments over time. Additionally, the platform enables users to compare events and cultural establishments that share the same time period on the same map, providing valuable insights into the interconnectedness of historical events and their impact on global civilization.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The invention pertains to The Global History Mapper a dynamic platform enabling collaborative editing and visualization of historical events and civilization spread. By harnessing crowd input, it digitizes human history onto a single map per period, offering a comprehensive view of global developments. Users can seamlessly navigate through time, observing cultural evolution and comparing concurrent events and establishments on interactive maps across human history.

### Description of the Related Art

The study of history has always been crucial for understanding the present and shaping the future. However, traditional methods of accessing historical information, such as textbooks and static maps, often limit engagement and fail to capture the dynamic and interconnected nature of human civilization. Key events are described in detail but also in isolation. Civilizations are viewed by themselves or as members of a region instead of components of a global world at their respective historical period. Recognizing the need for a more interactive and collaborative approach to studying history, the proposed invention seeks to revolutionize the way historical knowledge is accessed, recorded, and shared. By leveraging digital technologies, crowd contribution and interactive mapping capabilities, this invention aims to provide users with a versatile platform for exploring and analyzing historical events, trends, and developments.

According to UNESCO, historical literacy is essential for promoting global citizenship and fostering mutual understanding among people of different cultures and backgrounds. A survey conducted by the Pew Research Center found that only 12% of Americans have a proficient level of historical knowledge, highlighting the need for innovative approaches to history education. The digital revolution has transformed the way information is accessed and consumed, with the internet serving as a primary source of information for billions of people worldwide. The field of digital humanities has witnessed significant growth in recent years, with scholars and researchers utilizing digital tools and technologies to analyze and interpret historical data in new and innovative ways.

Various innovations have been made in the field of digital history and interactive mapping, aiming to enhance the accessibility and usability of historical information. These innovations include interactive historical maps that allow users to explore different time periods and regions, providing contextual information and multimedia content. Collaborative platforms for crowdsourcing historical data and engaging users in the process of digitizing and curating historical records have also emerged. Augmented reality (AR) and virtual reality (VR) technologies enable users to immerse themselves in historical environments and events, offering a more immersive and interactive learning experience. Additionally, data visualization techniques transform complex historical datasets into interactive visualizations, making it easier for users to analyze and interpret historical trends and patterns.

Multiple innovations have been seen in similar field. For instance, a U.S. Pat. No. 9,519,692 B2 relates to visualizing related events within a timeline. The timeline visualization system displays one or more groups of related events over a specified period of time within a timeline, where each group of related events is represented within the timeline as an event group. When a user interacts with the timeline, the event group expands and displays all the related events within the event group in a layer on top of the timeline. When a user interacts with the timeline a second time, the event group collapses, and the timeline (including the one or more event groups), is once again displayed.

An EP patent 0,972,72A1 Interactive timeline visualization relates to a system for graphically displaying an item (having a plurality of elements) on a display device as the item appears at a preselected time in a timeline first determines which of the plurality of elements are later in the timeline than the preselected time. Once this is determined, first and second sets of elements are defined, in which the elements in the first set each have a respective associated time that is no later than the preselected time. The second set of elements, however, includes each of the elements not in the first set of elements. The number of elements in each of the first set and the second set can range from no elements to many elements. The elements in the first set are drawn on the display device in a first format, and the elements in the second set are drawn on the display device in a second format. The second format, however, graphically indicates that the elements in the second set have respective times that each are later than the preselected time. As such, the first format and second format preferably are different.

A U.S. Pat. No. 11,150,778 relates to system and method for visualization of history of events using BIM model. The method and apparatus including the steps of a building information model (BIM) of a security system providing a three-dimensional view of a secured area of the security system including the physical location of any sensors of the security system, an input device of the security system receiving from a user a starting time and ending time of a time interval of interest and a processor of the security system displaying the three-dimensional view of the secured area including a time scale showing the starting time on one end of the time scale and the ending time at an opposing end of the time scale and a respective popup of details for each corresponding sensor of at least some sensors of the security system activated during the time interval of interest, each respective popup graphically connected to the physical location of the corresponding sensor within the three dimensional view.

The proposed invention offers several key benefits. Enhanced Accessibility: By providing a user-friendly platform accessible through any web browser, the invention democratizes access to historical knowledge, allowing people from all walks of life to engage with and contribute to the digitization of human history. Collaborative Contribution: The invention fosters a collaborative approach to digitizing history by enabling simultaneous edits on historical maps, encouraging users worldwide to share their knowledge, insights, and perspectives on significant historical events and cultural phenomena, jointly painting a world in the past through civilization spreads and key events mapped in a single world. Interactive Exploration: Through interactive features and dynamic mapping capabilities, the invention enhances the educational experience by offering users a hands-on approach to exploring and analyzing historical data in a holistic global view, fostering a deeper understanding of human history. Preservation and Archival: The invention facilitates the preservation and archival of historical records by providing a digital repository for historical maps and data, ensuring that valuable historical information is safeguarded for future generations, not in isolation but also with geographical accuracy and in chronological sequence. Cultural Exchange: By showcasing the rich diversity of human civilizations across time and space, the invention promotes cultural exchange and understanding, encouraging users to explore and appreciate different cultures and societies from around the world. Overall, the proposed invention represents a significant advancement in the field of digital history, offering a versatile platform for accessing, recording, and sharing historical knowledge in a collaborative and interactive manner.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims and abstract as a whole.

The primary desirable object of the present invention is to democratize access to historical knowledge by providing a user-friendly platform accessible through any web browser, allowing people from all walks of life to engage with and contribute to the digitization of human history, jointly building a global civilization map in chronological order

It is also the primary objective of the invention to foster a collaborative approach to enrich human footprint in the past by enabling simultaneous edits on historical maps, which includes the abilities to map and edit details for civilization, locate and edit details for historical events, encouraging users worldwide to share their knowledge, insights, and perspectives on significant historical events and cultural phenomena.

It is another objective of the invention to promote historical literacy and critical thinking skills by offering interactive features that allow users to explore and analyze historical data dynamically and engagingly, fostering a deeper understanding of the complexities of human history.

Another object of the present invention is to facilitate the preservation and archival of historical records by providing a digital repository for historical maps and data, ensuring that valuable historical information is safeguarded for future generations.

It is further the object of the invention to enhance educational experiences by offering educators and students interactive tools for teaching and learning about history, enabling them to explore historical events and developments in an immersive and engaging way, promoting a casual approach to history.

It is a further object of the present invention to promote cultural exchange and understanding by showcasing the rich diversity of human civilizations across time and space, encouraging users to explore and appreciate different cultures and societies from around the world. A key objective of the inventor in today's progressively fragmenting world.

It is also the objective of the invention to empower individuals to discover and share stories from their own communities and cultural heritage, enabling them to contribute to the collective understanding of human history and celebrate the richness of global cultural heritage.

It is also the objective of the invention to facilitate interdisciplinary research and collaboration by providing historians, archaeologists, sociologists, and other scholars with a versatile platform for studying and analyzing historical data, fostering new insights and discoveries.

It is furthermore the objective of the invention to allow range of benefits, such as the mapping of historical events, enabling a deeper understanding of significant occurrences, and offering chronological views. Users will have the ability to explore historical timelines, gaining insights into the interconnectedness of events and their impact over time. Additionally, the invention facilitates the visualization of historical data in an organized and accessible manner, allowing users to navigate through historical periods with ease. Through these features, users can enhance their knowledge and comprehension of historical events and their broader context.

Thus, it is the objective to inspire curiosity and lifelong learning by offering users of all ages and backgrounds an engaging and immersive experience that sparks interest in history and encourages exploration of the past. Other aspects, advantages and novel features of the present invention will become apparent from the detailed description of the invention when considered in conjunction with the accompanying claims.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As per preferred embodiments, the invention, represents a pioneering innovation designed to designed to revolutionize the recording, visualization, and exploration of human history. Accessible through any web browser, this HTML/JAVA-based system serves as a dynamic hub for documenting historical events and the spread of civilization across Earth's timeline. Unlike traditional static maps or historical databases, this platform enables users to actively participate in the creation and curation of historical data, fostering a collaborative and interactive approach to studying the past.

As per its further embodiments, its core, the invention allows for simultaneous edits on a map, enabling users to document historical events, landmarks, and cultural establishments across different time periods. Through crowd input, users contribute to the digitization of human history onto single maps designated for each specific time period, potentially resulting in a comprehensive archive of global historical events on a monthly to yearly basis depending on the speed of change and frequency of historical events. This ambitious goal aims to capture the richness and diversity of human civilization throughout the ages, providing invaluable insights into the evolution of societies and cultures.

As per its further embodiments, one of the key features of the platform is its interactive interface, which empowers users to navigate between different time periods seamlessly. By flipping between historical maps, users can visualize the progression and transformation of key cultural establishments over time, gaining a deeper understanding of historical trends and developments. Additionally, the platform facilitates comparisons between events and cultural phenomena that coincide within the same time period, allowing users to explore the interconnectedness of historical events and their impact on global civilization instead of viewing events in isolation or with a regional perspective.

As per its further embodiments, the invention leverages advanced technologies to ensure the accuracy, reliability, and accessibility of historical data. Through crowd verification processes and user-generated content, the platform maintains high standards of historical integrity while encouraging ongoing contributions from users worldwide. Furthermore, the system archives historical maps and data to preserve digital records of human history for future generations, serving as a valuable resource for educators, researchers, and enthusiasts alike.

As per its further embodiments, in addition to its educational and research applications, the platform offers various opportunities for innovation and expansion. As new historical data becomes available and technological capabilities evolve, the platform can adapt and incorporate these advancements, enriching the user experience and further enhancing our understanding of human history. With its comprehensive coverage, interactive features, and collaborative approach, the proposed invention represents a significant step forward in the digitization and exploration of human history on a global scale.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A digital platform for recording historical events and the spread of civilization, accessible via any web browser or specific mobile application.

2. A system enabling simultaneous edits on a map to document historical events and civilization spread.

3. A system of claim 2, that allows edits of details for each created historical events and civilization such as name, synopsis for events, ruler and government for civilizations for incorporating user-generated content and feedback to continually enrich historical data.

4. A system of claim 2, with crowd-input reliant platform for digitizing human history onto single maps for each designated time period.

5. A system of claim 2, with an HTML-based interface allowing users to freely navigate between civilizations and historical events as well as displaying its edited details when selected.

6. A system of claim 2, with a feature allowing users to navigate between different time periods to visualize the evolution of key cultural establishments.

7. A system of claim 2, providing comprehensive coverage of global historical events and civilization developments.

8. A system of claim 2, providing a tool for facilitating collaborative editing and contribution of historical data by users worldwide.

9. A system of claim 2, with an interactive interface for users to engage with historical maps and explore various cultural phenomena.

10. A system of claim 2, with a functionality enabling users to customize their viewing experience by selecting specific time periods of interest.

11. A system of claim 2, for ensuring the accuracy and reliability of historical information through crowd or expert verification.

12. A system of claim 2, for archiving historical maps and data to preserve digital records of human history.

13. A system of claim 2, with a feature for facilitating educational use, allowing teachers and students to explore historical events interactively and in a slideshow fashion.

14. A system of claim 2, with a platform adaptable to future advancements and expansions, capable of incorporating new historical data and functionalities.
